(19) United States
(12) Patent Application Publication
(10) Pub. No.: US 2016/0232326 A1
(43) Pub. Date: Aug. 11, 2016

(54) METHOD FOR HEALTH ASSESSMENT AND NUTRITIONAL FORTIFICATION DURING PREGNANCY

(71) Applicant: GROWBABY, LLC, Ashland, OR (US)

(72) Inventors: Emily A. Rydbom, Ashland, OR (US); P. Michael Stone, Ashland, OR (US); Leslie P. Stone, Ashland, OR (US)

(73) Assignee: GROWBABY, LLC, Ashland, OR (US)

(21) Appl. No.: 14/991,917

(22) Filed: Jan. 9, 2016

Related U.S. Application Data
(60) Provisional application No. 62/113,238, filed on Feb. 6, 2015.

(51) Int. Cl. G06F 19/00; G06F 19/18

(52) U.S. Cl. CPC G06F 19/3475; G06F 19/18

(57) ABSTRACT

A method for health assessment and nutritional fortification during pregnancy enables a mother to interactively work with a caregiver to manage pregnancy from preconception through the period of breastfeeding, so as to enhance the mother's maternal health and achieve an appropriate birth weight for the baby. The method provides a battery of health tests designed to identify needs and special conditions of the mother. The health test includes genomics analysis. A customized nutritional plan and supplemental program supply both the mother and the baby with the necessary vitamins and nutrients during and after birth. The mother records information pertinent to food intake and general pregnancy. The recorded information is used by the caregiver for analysis, and also to educate the mother and network of mothers. The mother and caregiver interact to formulate an individual pregnancy plan during the duration of the pregnancy based on the health assessments and supplements.

### CROSS REFERENCE OF RELATED APPLICATIONS

This application claims the benefits of U.S. provisional application No. 62/113,238, filed Feb. 6, 2015 and entitled PREGNANCY MANAGEMENT METHOD, which provisional application is incorporated by reference herein in its entirety.

### FIELD OF THE INVENTION

The present invention relates generally to a method for health assessment and nutritional fortification during pregnancy. More so, the present invention relates to a method that enables a mother to manage pregnancy from the period of preconception to the period of breastfeeding through a comprehensive program of health assessments, laboratory tests, nutritional intake, and supplemental intake; whereby the method allows the mother and the caregiver to formulate an individual pregnancy plan based on the comprehensive program, so as to decrease maternal health risks and improve baby birth weights.

### BACKGROUND OF THE INVENTION

Typically, human pregnancy is the time during which a child develops inside the womb of a woman. Pregnancy can occur by sexual intercourse or assisted reproductive technology. Typically, pregnancy lasts approximately 40 weeks from the last menstrual period and ends in childbirth. Specifically, human pregnancy is divided roughly into three trimesters, each approximately three months long. The first trimester is from the last period to the 13th week, the second trimester is from the 14th to 27th week, and the third trimester is from the 28th week to the 42nd week. Typically, from the period of preconception through the period of breastfeeding the mother is mentally and physically stressed, requiring regular health assessments and enhanced nutrition.

It is known in the art that prenatal medical care is the medical and nursing care recommended for women during pregnancy, time intervals and exact goals of each visit differ by country. Women who are low and high risk, or regardless of risk have better outcomes if they are seen regularly and frequently by a medical professional. The aim of good prenatal care is prevention, early identification, and treatment of any medical complications.

In many instances, prenatal care is a type of preventive healthcare with the goal of providing regular check-ups that allow doctors or midwives to treat and prevent potential health problems throughout the course of the pregnancy while promoting healthy lifestyles that benefit both mother and child. During check-ups, women will receive medical information over maternal physiological changes in pregnancy, biological changes, and prenatal nutrition including prenatal vitamins. Recommendations on management and healthy lifestyle changes are also made during regular check-ups.

Often, a prenatal visit consists of measurement of blood pressure, fundal height, weight and fetal heart rate, checking for symptoms of labor, and guidance for what to expect next. The amount of healthy weight gain during a pregnancy varies. Weight gain is related to the weight of the baby, the placenta, extra circulatory fluid, larger tissues, and fat and protein stores.

Generally, enhanced nutrition during pregnancy is important to ensure healthy growth of the fetus. Nutrition during pregnancy is different from the non-pregnant state. There are increased energy requirements and specific micronutrient requirements. Women benefit from education to encourage a balanced energy and protein intake during pregnancy. Some women may need professional medical advice from a nutritionist if their diet is affected by medical conditions, food allergies, or ethical beliefs.

It is known that relatively common morbidities in pregnancy include maternal high blood pressure and high blood sugar. It is also known that the risk of babies who are born too small or too large for gestational age is decreased when the high blood pressure and high blood sugar are controlled through medical assessments, exercise, proper nutrition, and supplements. This is crucial to improved health outcomes, as these are the babies who have the greatest trajectory for disease risk as an adult.

It is also known that healthcare costs for an expecting mother can be expensive. One way to reduce healthcare costs is through healthcare prenatal care where health-related information is collected from individuals and used to improve healthcare management. For example, screening may be used to provide a health risk factor assessment or to provide early detection of disease. This information may allow an individual to get appropriate care in a timely manner. In some cases, receiving early treatment may reduce overall healthcare cost as compared to those costs when certain diseases go undetected or when certain risk factors are ignored. Additionally, in some cases timely treatment may provide a better quality of health and a better quality of life for the individual.

Often, web-based health assessments are generally paper-based surveys placed on the Internet. Such health assessments do not take advantage of the various capabilities that the Internet provides, such as interactivity or attention-grabbing techniques. Simply put, existing health assessment surveys, whether paper-based or web-based, simply provide no means to engage the user or otherwise provide an interactive experience. These assessments are often boilerplate, and thereby not customized to the needs of the mother.

Other proposals have involved pregnancy management methods. The problem with these methods is that they do not create a unique synergy between health assessments, clinical tests, nutrition, supplements, and interaction between mother and caregiver to formulate an individual pregnancy plan for the mother during and after pregnancy. Even though the above cited pregnancy methods meet some of the needs of the market, a method for health assessment and nutritional fortification during pregnancy that enables a mother to receive systematic health assessments, customized nutrition, and eclectic supplements, and then interact with a caregiver to manage the pregnancy from the period of preconception through the period of breastfeeding to formulate an individual pregnancy plan for the mother is still desired.

### SUMMARY

Illustrative embodiments of the disclosure are generally directed to a method for health assessment and nutritional fortification during pregnancy. The method enables a mother to receive systematic health assessments, customized nutrition, and eclectic supplements, and then interact with a caregiver to manage the pregnancy from the period of preconception through the period of breastfeeding to formulate an individual pregnancy plan for the mother.

In one embodiment, the method utilizes a comprehensive battery of health assessments, laboratory tests, nutritional plans, and systematic recording of nutritional intake and general pregnancy information. These are designed to help decrease maternal health risks of the mother and improve birth weights of the baby. The health assessments and nutritional intake are recorded for viewing by the mother and the caregiver. The mother and the caregiver interact to formulate an individual pregnancy plan as the conditions and stages of the pregnancy change.

In some embodiments, the method performs on the mother a battery of health tests to help identify needs and special conditions of the mother. The health tests may also include genomics analysis. The method integrates customized nutritional plans and vitamin supplements to helps supply both the mother and the baby with the necessary vitamins and nutrients before conception, and during and after birth.

After assessment of the health tests, laboratory analyses, and effects of the nutritional intake, the caregiver analyzes the information to formulate, with the mother, an individual pregnancy plan. The individual pregnancy plan provides easy-to-use tools designed to improve the efficacy of the method. Additionally, the method incorporates sleep management, stress management, and general education about nutrition and breastfeeding.

The mother fully participates in the method by recording information pertinent to food intake and her general pregnancy. The recorded information may be used to enhance the method and educate the mother, the caregiver, and a network of mothers. The recorded progress of the mother may be monitored in real time on a website through a communication device. The mother may interact with the caregiver and/or a dedicated website to formulate the individual pregnancy plan. The individual pregnancy plan may include, without limitation nutritional and supplemental intake plans, exercise regimens, doctor visits that are all variably adaptable through the different periods of pregnancy.

One aspect of a method of pregnancy management, comprises:
performing at least one individual health assessment during preconception;
performing at least one genomics analysis pertinent to the pregnancy to at least partially understand a biological system;
performing at least one initial laboratory test during preconception to assess maternal health;
performing at least one secondary laboratory test during duration of the pregnancy and subsequent to the pregnancy to assess maternal health;
providing a nutritional plan during duration of the pregnancy and subsequent to the pregnancy to enhance maternal health;
providing a supplemental program preconceptionally and during duration of the pregnancy and subsequent to the pregnancy, the supplemental program comprising at least one supplement, the at least one supplement including at least one member selected from the group consisting of: at least one probiotic, at least one vitamin, at least one omega-3 fatty acid, and at least one methyl folate;
recording food intake and general pregnancy information during duration of the pregnancy and subsequent to the pregnancy; and
formulating an individual pregnancy plan during duration of the pregnancy and subsequent to the pregnancy, the individual pregnancy plan based on at least one of the following: the at least one health assessment, the at least one genomics analysis, at least one initial laboratory test, at least one secondary laboratory test, the nutritional plan, and the supplemental program.

In another aspect, the method comprises a step of providing at least one premade nutritional meal, subsequent to the pregnancy.

In another aspect, the method is operable from preconception to breast feeding.

In another aspect, the at least one individual health assessment comprises a general overview of health during preconception.

In another aspect, the general overview of health includes at least one member selected from the group consisting of: a visit to an obstetrician or pregnancy provider, a visit to a nutritionist, an anthropometric assessment, a nutritional intake assessment, a sleep evaluation, a stress evaluation, and an exercise program.

In another aspect, at least one genomics analysis comprises MTHFR C677T/A1298C, 3 SNPs of COMT, and others with pertinent interpretations and assessments thereof.

In another aspect, the at least one initial laboratory test includes at least one member selected from the group consisting of: a comprehensive metabolic panel, a complete blood panel, a thyroid panel, an essential fatty acid panel, and at least one vitamin test.

In another aspect, the at least one secondary laboratory test includes at least one member selected from the group consisting of: a complete blood panel, a comprehensive metabolic panel, a thyroid panel, at least one vitamin test, and analysis for at least one of the following: vitamin D, iron, zinc, carnitine, thyroid panel, 1 HR GTT, rubella, hepatitis B surface antigen, RPR, blood type, RH factor, chlamydia, gonorrhea, HIV, and a group B strep analysis.

In another aspect, the supplement is preGenesis® prenatal supplement.

In another aspect, the data storage device includes at least one member selected from the group consisting of: a server, a database, a processor, a cloud network, and a call center.

In another aspect, the method utilizes a software application to enable access to the data storage device.

In another aspect, the method conforms to the different trimesters of pregnancy.

In another aspect, the method is administered by a caregiver.

In another aspect, the caregiver includes at least one member selected from the group consisting of: an obstetrician, a midwife, a nursing mother, and a nutritionist/dietitian.

One objective of the present invention is to provide a comprehensive method for managing pregnancy preconception, during conception, and post conception.

Another objective is to supplement the mother's body with at least one vitamin and at least one nutrient lost during pregnancy, and also to sufficiently feed both the mother and the baby.

Another objective is to educate the mother about the nutritional aspects of pregnancy.

Yet another objective is to monitor the mother thought the stages of pregnancy.

Yet another objective is to provide advice on sleep, stress management, and breastfeeding to the mother.

Yet another objective is to record nutritional intake and general pregnancy information on a daily pattern for receiving accurate analysis by caregivers and advice from other mothers.

Yet another objective is to reduce high blood sugar and high blood pressure in a mother.

Yet another objective is to collect the laboratory tests, the genomics analysis, and the mother's recorded information for future analysis to enhance the method for subsequent mothers and babies.

### BRIEF DESCRIPTION OF THE DRAWINGS

The invention will now be described, by way of example, with reference to the accompanying drawings, in which:

FIG. 1 illustrates a flowchart diagram of an exemplary pregnancy management method, in accordance with an embodiment of the present invention;

FIG. 2 illustrates a label of the ingredients in an exemplary supplement, in accordance with an embodiment of the present invention; and

FIG. 3 illustrates an exemplary individual pregnancy plan for a mother, showing a snapshot for the month of pregnancy based on health assessments, nutritional intake, and supplemental intake, in accordance with an embodiment of the present invention.

Like reference numerals refer to like parts throughout the various views of the drawings.

### DETAILED DESCRIPTION OF THE INVENTION

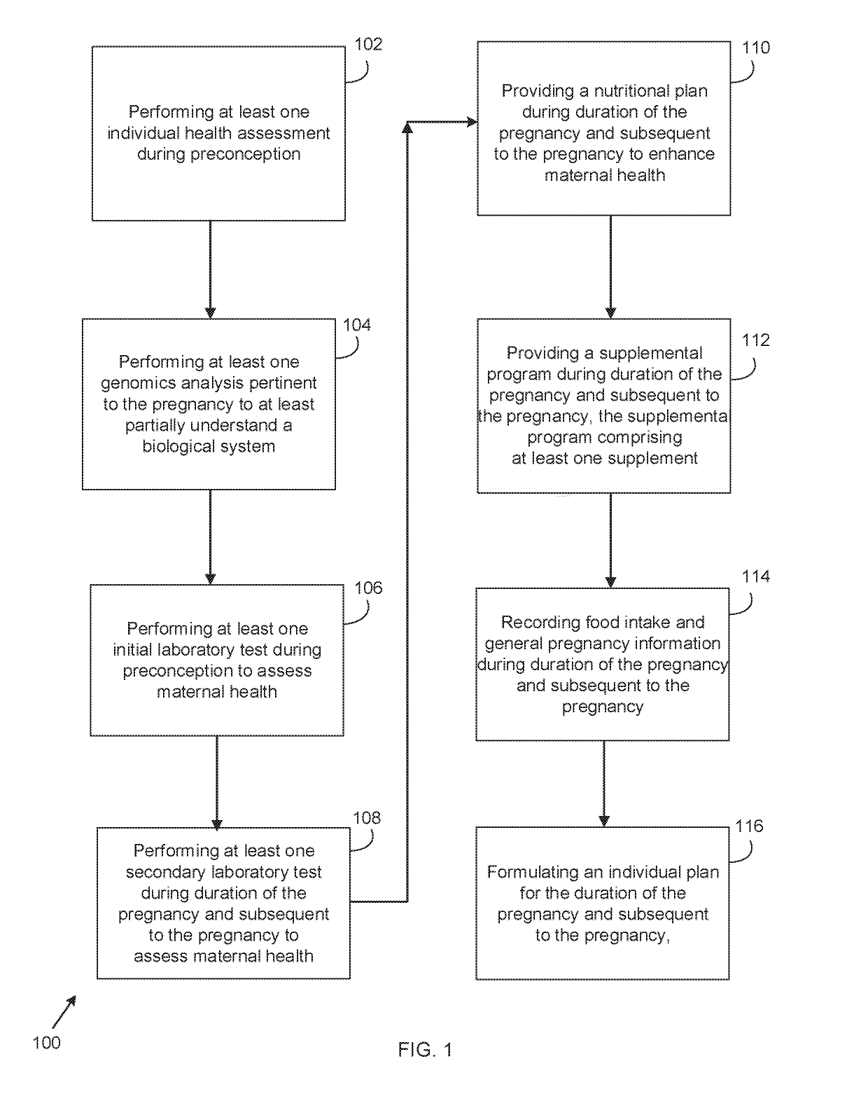

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A pregnancy management method 100 for health assessment and nutritional fortification during pregnancy is referenced in FIGS. 1-3. The method 100 provides comprehensive steps that create a healthful environment for the mother, so as to achieve enhanced maternal health and normal birth weights. The method 100 provides the mother with a systematic battery of health assessments, targeted laboratory tests, customized nutrition, and eclectic supplements. These health parameters are designed to help decrease maternal health risks of the mother and improve birth weights of the baby. The health assessments, nutritional intake, and supplemental intake are recorded for viewing by the mother and the caregiver. The mother and the caregiver interact to formulate an individual pregnancy plan 300 based on the health assessments, nutritional intake, and supplemental intake as the conditions and stages of the pregnancy change.

In some embodiments, the method 100 is configured to deduce the health assessment of the mother through a battery of health tests during the course of the pregnancy. The health tests help to identify special needs and conditions of the mother. The method also integrates customized nutritional plans and vitamin supplements into the mother's regimen to supply both the mother and the baby with the necessary vitamins and nutrients during and after birth.

After assessment of the health tests, laboratory analysis, and effects of the nutritional intake, the caregiver analyzes the information to assess the condition of the mother. Using this medical information, the caregiver may formulate, with the mother, an individual pregnancy plan. The individual pregnancy plan provides easy-to-use tools designed to improve the efficacy of the method. Additionally, the method incorporates sleep management, stress management, and general education about nutrition and breastfeeding.

The mother fully participates in the method by recording information pertinent to food intake and her general pregnancy. The recorded information may be used to enhance the method and educate the mother, the caregiver, and a network of mothers. The recorded progress of the mother may be monitored in real time on a website or through a communication device. The mother may interact with the caregiver and/or a dedicated website to formulate the individual pregnancy plan. The individual pregnancy plan may include, without limitation nutritional and supplemental intake plans, exercise regimens, doctor visits—all variably adaptable through the different periods of pregnancy.

By following the steps of the method 100, the mother feels supported throughout the entire nine months of pregnancy and beyond during the breastfeeding period. This support is inherent in the method through use of individualized assessment of each unique mother and her biological needs and condition. This includes assessing and enhancing the mother through anthropometrics, lab work, nutrition, supplements, and lifestyle. Following interpretation of the health assessment, laboratory analysis, and effects of the nutritional and supplemental intake, an individual pregnancy plan is formulated for the mother. The individual pregnancy plan 300 follows the conditions and stages of the pregnancy, and uses easy-to-use tools that facilitate understanding and use by the mother and the caregiver.

As referenced in FIG. 1, the method 100 provides a battery of health tests for the mother to help identify needs and special conditions associated with her pregnancy. The health tests may include, without limitation, a diverse array of scientific tools, including, without limitation, anthropometrics, blood tests, laboratory tests, supplements, therapy, and lifestyle changes. These programs are followed by an individual nutritional plan and a systematic recording of nutritional intake. The health tests may also include genomics analysis.

In some embodiments, a customized nutritional plan and supplemental program having a supplement 200 helps supply both the mother and the baby with the necessary vitamins 204 and nutrients during and after birth. The mother records information pertinent to food intake and general pregnancy. The recorded information may be used to enhance the method 100 and educate the mother, the caregiver, and a network of mothers.

In some embodiments, the recorded progress of the mother may be monitored in real time on a website through a communication device. The mother may also interact with a caregiver and website to alter the nutritional intake. Additionally, sleep management, stress management, and general education about nutrition and breastfeeding is provided.

In some embodiments, the method 100 may be effective for enhancing the maternal health during pregnancy through prenatal preventive healthcare with the goal of providing regular check-ups that allow caregivers, such as doctors or midwives, to treat and prevent potential health problems throughout the course of the pregnancy while promoting healthy lifestyles that benefit both the mother and baby.

The method 100 comprises multiple steps that are applied throughout the entire nine months of pregnancy, from the period prior to conception to post-conception. The steps of the method 100 utilize an eclectic program that is customized for the mother based on health assessments and the stage of pregnancy.

FIG. 1 illustrates a flowchart diagram of an exemplary method 100 of pregnancy management. The method 100 manages pregnancy from preconception through the period of breastfeeding with a comprehensive program of health assessments, laboratory tests, nutritional plans, and systematic recording of nutritional intake to help decrease maternal health risks and improve birth weights.

The method 100 may include an initial Step 102 of performing at least one individual health assessment during preconception. In one embodiment, the at least one individual health assessment may include, without limitation, anthropometrics, evaluation of nutrition, sleep management, stress, and exercise management. The health assessment is also used to obtain a general health status of the mother, and may include a questionnaire for family health history, a physical, and questions about nutritional intake. The health assessment utilizes at least one health test. The health test may include, without limitation, a diverse array of scientific tools, including, without limitation, anthropometrics, blood tests, laboratory tests, supplements, therapy, and lifestyle changes.

While obtaining the information of the health assessment, a caregiver takes the initial steps to understand the health, history, and concerns of the mother. The caregiver may include, without limitation, an obstetrician, a gynecologist, a midwife, a nursing mother, and a nutritionist. Because the individual health assessment generally occurs during preconception, the collected health information may serve as a base line for subsequent tests on the mother and baby. The health information may also be used for subsequent pregnancies.

The method 100 may further comprise a Step 104 of performing at least one genomics analysis pertinent to the pregnancy to at least partially understand a biological system. The genomics analysis provides a deeper analysis into the well-being and medical history of the mother. DNA sequencing methods and bioinformatics are analyzed to sequence, assemble, and analyze the function and structure of genomes. Thus, by genetically mapping the DNA of the mother, possible diseases may be anticipated, and supplemental programs can better be tailored to the mother. In one embodiment, the genomics analysis may include, without limitation, MTHFR C677T/A1298C, 3 SNPs of COMT with interpretations and assessments.

A Step 106 includes performing at least one initial laboratory test during preconception to assess maternal health. The initial laboratory test involves a more intrusive assessment of the mother than the individual health assessment discussed in Step 102. The at least one initial laboratory test may include, without limitation, a comprehensive metabolic panel, a complete blood panel, a thyroid panel, and an essential fatty acid panel. There may also be tests to determine the content of vitamins 204 in the mother, including, without limitation, vitamin D, iron, zinc, carnitine, magnesium, RBC mineral, and heavy metal. Further initial laboratory tests may include allergy testing and organic acid testing.

In some embodiments, a Step 108 comprises performing at least one secondary laboratory test during duration of the pregnancy and subsequent to the pregnancy to assess maternal health. The secondary laboratory test occurs subsequent to the initial laboratory test and builds on the information gathered form the initial laboratory tests. The secondary laboratory test may be performed in stages during the life of the pregnancy, generally in trimesters. In one embodiment, the at least one secondary laboratory test is performed on the mother between the first and second trimesters.

Prior to beginning the secondary laboratory tests, a first screening is performed, which may include genetic screening for aneuploidy and ultrasound for congenital defects. The genome data gathered from Step 104 may be used for the screening. The secondary laboratory test may include, without limitation, a complete blood panel, a comprehensive metabolic panel, tests for at least one of the following: vitamin D, iron, zinc, carnitine, thyroid panel, 1 HR GTT, rubella, hepatitis B surface antigen, RPR, blood type, RH factor, chlamydia, gonorrhea, HIV, and a group B strep analysis.

A Step 110 includes providing a nutritional plan to enhance maternal health, during duration of the pregnancy and subsequent to the pregnancy. The nutritional plan helps maintain optimal health of the mother during pregnancy. The nutritional plan provides meals that help curb excessive weight gain, provides nutritional food, restrict unhealthy foods, and in some embodiments, may even conform to religious dietary guidelines. The types of foods offered in the nutritional plan depend largely on the prior analysis performed in tests and genomics, as well as the trimester and the present health status of the mother.

The nutritional plan utilizes a macro/micronutriture system that covers all trimesters and types of mothers. In some embodiments, the nutritional plan may divide the types and amounts of food into the different trimesters of pregnancy. For example, foods with a greater folate (folic acid) content are provided immediately prior to conception. The nutritional plan also compensates for the fact that the food intake accounts for the mother and the baby, and is adjusted according to healthy weight gain, pre-existing BMI, and medical history. In one embodiment, a trimester by trimester nutrition education program may be provided with the nutritional plan. The nutrition education program may be given in a clinic with weekly classes, individual appointments, and eLearning modules accessed online for free.

Those skilled in the art, in light of the present teachings, will recognize that fortified foods are included in the nutritional plan, such as fortified breakfast cereals or orange juice with calcium. It is also known in the art that folate (folic acid) is necessary, especially prior to conception and in the early weeks of pregnancy, to help prevent birth defects of the brain and spine. The nutritional plan may also include natural sources such as orange juice, green leafy vegetables, beans, peanuts, broccoli, asparagus, peas, lentils, and whole grain products.

In one embodiment, the nutritional plan comprises at least: 1 to 4 servings of grain products; 6 to 10 servings of vegetables; 2 to 4 servings of fruits; 1 to 2 servings of dairy and dairy products; 1 to 2 servings of legumes; 10 to 18 servings (1 oz. per serving) of meat and protein foods; 8 to 16 glasses of clear fluid which includes water and herbal tea; and limited servings of sweets, in the form of dark chocolate, maple syrup, honey, and molasses. Examples of the types of foods found in the nutritional plan may include, without limitation, yogurt, broccoli, lentils, and figs. Those skilled in the art will recognize that these foods are generally full of Vitamin C, folate (folic acid), and calcium, which the pregnant mother's body requires. Those skilled in the art, in light of the present teachings, will also recognize that the mother requires higher levels of vitamin 204 supplementation during pregnancy. Thus, the nutritional plan may include prenatal vitamins containing iron (for healthy blood) and calcium (for healthy bones).

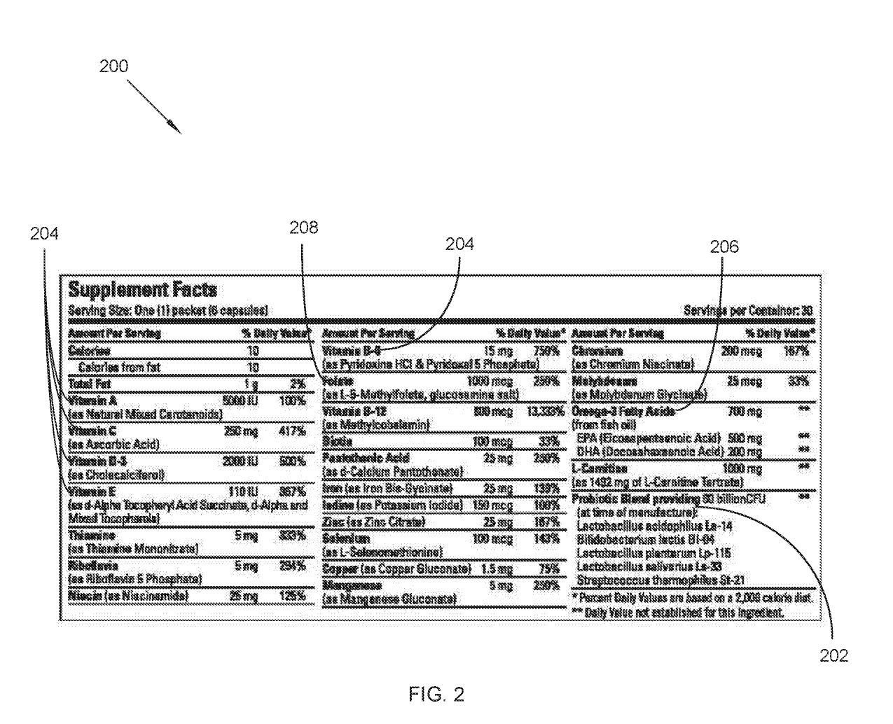

In some embodiments, a Step 112 may include providing a supplemental program during duration of the pregnancy and subsequent to the pregnancy, the supplemental program comprising at least one supplement 200 (FIG. 2). The at least one supplement comprises at least one member selected from the group consisting of: at least one probiotic 202, at least one vitamin 204, at least one omega-3 fatty acid 206, and at least one methyl folate 208. Though in other embodiments, additional supplements may be added, including, without limitation, calcium, thiamine, riboflavin, biotin, pantothenic acid, iron, iodine, zinc, selenium, copper, manganese, chromium, and molybdenum. An exemplary supplemental plan may include the following:

Supplements

| Supplement | Serving | | % Daily | Supplement | Serving | | % Daily | Supplement | Serving | | % Daily |
|---|---|---|---|---|---|---|---|---|---|---|---|
| Vitamin A | 5000 | IU | 2% | Folate | 1000 | mcg | 250% | Copper | 1.5 | mg | 75% |
| Vitamin C | 250 | mg | 417% | Vitamin B-12 | 15 | mcg | 750% | Manganese | 2* | mg | 250% |
| Vitamin D-3 | 2,000 | IU | 500% | Biotin | 100 | mcg | 33% | Chromium | 200 | mcg | 167% |
| Vitamin E | 110 | IU | 367% | Pantothenic Acid | 25 | mg | 250% | Molybdenum | 25 | mcg | 33% |
| Thiamine | 5 | mg | 333% | Iron | 25 | mg | 139% | Omega-3 Fatty | 700 | mg | ** |
| Riboflavin | 5 | mg | 294% | Iodine | 150 | mcg | 100% | L-Carnitine | 1000 | mg | ** |
| Niacin | 25 | mg | 125% | Zinc | 25 | mg | 167% | | | | |
| Vitamin B-6 | 15 | mg | 750% | Selenium | 100 | mcg | 143% | | | | |

*Future dosages may be changed from 5 to 2 mg.

In some embodiments, the supplement 200 is administered as a pill or a liquid. In other embodiments, therapeutic doses of specific nutrients may, however, be administered individually. In either case, the supplement 200 is formulated to satisfy the common nutritional deficiencies encountered during pregnancy. In this manner, additional quantities of vitamins 204 and minerals are ingested by the mother that may otherwise not be consumed, or may be consumed by the baby leaving the mother deficient. In one embodiment, the supplement 200 is preGenesis® prenatal supplement formulated by a scientist and/or doctor.

A Step 114 comprises recording food intake and general pregnancy information during duration of the pregnancy and subsequent to the pregnancy. The information that is recorded may be grouped for analysis and used to recommend additional assistance and advice to the mother. Specifically, one advantage of recording the information is that the mother receives more accurate analysis by caregivers and advice from other mothers. In one possible embodiment, the information is shared on a network of mothers, or exclusively with a caregiver. While the mother records her nutritional intake, she is closely monitored by the caregiver, including the nutritionist.

Those skilled in the art will recognize that one advantage of recording nutritional intake may be that the types of foods being eaten by the mother are filtered to prevent undesirable foods from entering the nutritional plan. The software application may be programmed to provide a food filter for the mother, such that the mother is made aware of which foods are undesirable, and the nutritionist is made aware of what to include and not include in the nutritional plan. The food filter may include, without limitation, vegan, vegetarian, paleo for pregnancy, and dairy-free, soy-free, gluten-free, corn-free, peanut-free, shellfish-free, egg-free.

In some embodiments, the mother not only records the information, but also accesses pertinent information that is pertinent to the pregnancy and the nutritional program. The data storage device operatively connects to a server and additional gateways that the mother and/or caregiver can access. In one embodiment, the mother connects to the data storage device to access a website, a network of mothers on a social media site, eLearning modules, pregnancy pods, and blog sites. The data storage site may include, without limitation, a server, a database, a processor, the cloud network, and a call center. The data storage site may be accessed through a downloadable software application.

In one embodiment, the mother accesses the software through the website (growbabyhealth.com). In yet another embodiment, as the mother records the nutritional intake and general pregnancy information, the caregiver or the members of the social network of pregnant and nursing mothers direct the mother to a clinical class, a blood work panel, nutritional recipes, and supplemental guides. The recorded information forms, in essence, a trimester-by-trimester educational tool. In any case, the nutritional intake and general pregnancy information recorded by the mother is used to further enhance the pregnancy and subsequent months after the pregnancy.

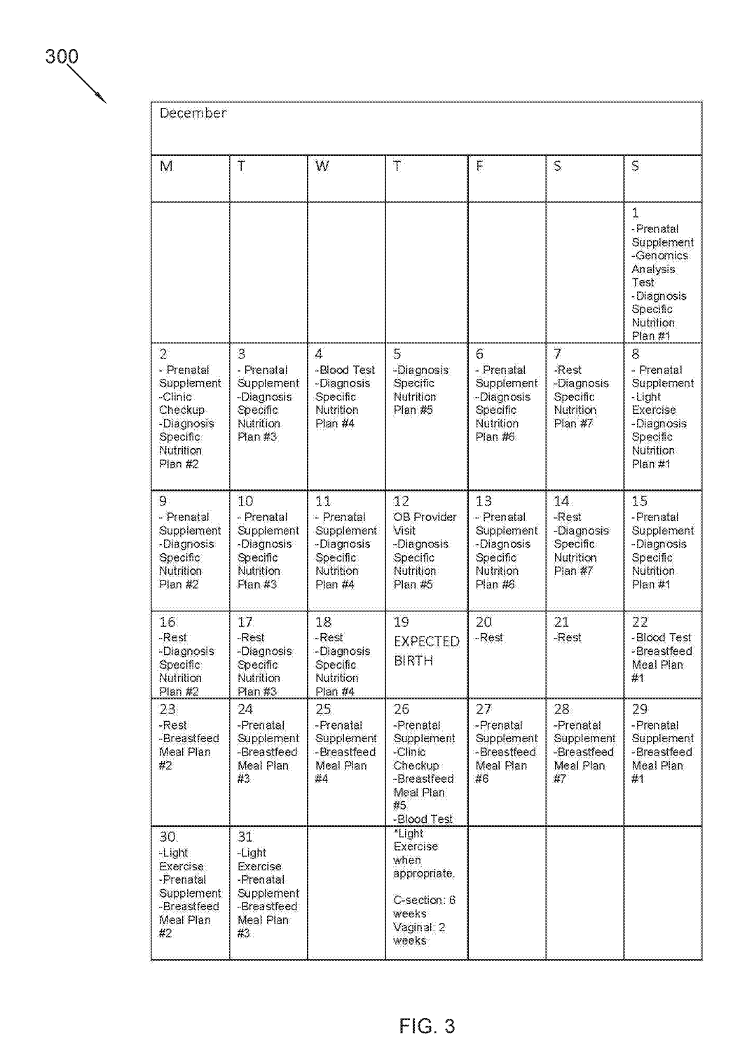

Turning now to FIG. 3, the method may further include a final Step 116 of forming an individual pregnancy plan 300 during the duration of the pregnancy and subsequent to the pregnancy. The individual pregnancy plan 300 in FIG. 3 references a snapshot for the month of pregnancy. Though additional months prior to, and subsequent to the pregnancy are also used. The individual pregnancy plan is customized to fit the maternal health needs of the mother. In one embodiment, the individual pregnancy plan 300 is based on at least one of the following: the at least one health assessment, the at least one genomics analysis, at least one initial laboratory test, at least one secondary laboratory test, the nutritional plan 300, and the supplemental program. The individual pregnancy plan is customized to the needs and desires of the mother and the baby. Though in some embodiments, the caregiver may provide more input and design of the individual pregnancy plan 300 than the mother.

In some embodiments, the individual pregnancy plan may be segregated into months and requirements of the mother, so that the mother has an easy to follow blueprint for applying the method appropriately. FIG. 3 illustrates an exemplary individual pregnancy plan for December, during the expected month of birth. The December individual pregnancy plan organizes, medical assessments, supplemental intake, nutritional meals, exercise, and rest in an easy to follow format. Each trimester of pregnancy may be configured into a similar format, changing with the nutritional and lifestyle management of pregnancy.

In another exemplary individual pregnancy plan, three months prior to birth, the mother reduces supplemental intake by ⅓. After birth, the mother commences light exercise. The individual pregnancy plan may be altered at any time due to health considerations. The individual pregnancy plan may be viewable on a communication device, such as a smart phone or computer by both the mother and the caregiver.

In one alternative embodiment, the method 100 includes a step that provides at least one premade nutritional meal subsequent to the pregnancy. The nutritionist and/or a food preparation organization may prepare premade meals that are tailored for a mother or groups of similar mothers. The premade meals incorporate the nutritional plan discussed in Step 210. The premade meals may be frozen and shipped directly to the mother. In one embodiment, the premade nutritional meals are customized for the different trimesters during the birth, and for the post birth breastfeeding period.

In one exemplary use of the method 100, the clinical and laboratory tests are analyzed, and the results are then customized into an individualized nutrition plan based off laboratory panels, DNA testing, gestational age, and maternal metabolic foundation. These are then paired with a supplement plan that is formulated to meet the common nutrient deficiencies of pregnancy.

In another embodiment, the mother is closely followed by both an obstetrician and a nutritionist who logs the daily food intake of the mother in a software application viewable by all parties involved. The mother is continuously reevaluated throughout her pregnancy with labs, and adjustments to nutrition, sleep, exercise, and stress management.

Furthermore, similar meticulous attention is given to the mother during preconception and breastfeeding. The features of the method 100 may include, without limitation, a website, social media sites, eLearning modules, blog site, in clinic classes per trimester, unique blood work panels, and unique prenatal supplement, and web-based nutritional app. In alternative embodiments, the method 100 allows for a maternal health/nutrition book and ready-to-eat meals prepared for consumption by the mother.

Thus, by applying the steps of the method, the long term health of the mother and the birth weight of the baby are enhanced. Specifically, high blood sugar and high blood pressure, which are relatively common health problems during pregnancy, may be reduced. With healthier mothers and babies, a significant impact can be made on the disease risk in a generational way.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A method for health assessment and nutritional fortification during pregnancy, the method comprising:
performing at least one individual health assessment during preconception;
performing at least one genomics analysis pertinent to the pregnancy to at least partially understand a biological system;
performing at least one initial laboratory test during preconception to assess maternal health;
performing at least one secondary laboratory test during duration of the pregnancy and subsequent to the pregnancy to assess maternal health;
providing a nutritional plan during duration of the pregnancy and subsequent to the pregnancy to enhance maternal health;
providing a supplemental program during duration of the pregnancy and subsequent to the pregnancy, the supplemental program comprising at least one supplement, the at least one supplement including at least one member selected from the group consisting of: at least one probiotic, at least one vitamin, at least one omega-3 fatty acid, and at least one methyl folate;
recording food intake and general pregnancy information during duration of the pregnancy and subsequent to the pregnancy; and
formulating an individual pregnancy plan during the duration of the pregnancy and subsequent to the pregnancy, the individual pregnancy plan based on at least one of the following: the at least one health assessment, the at least one genomics analysis, at least one initial laboratory test, at least one secondary laboratory test, the nutritional plan, and the supplemental program.

2. The method of claim 1, further including a step of providing at least one premade nutritional meal subsequent to the pregnancy.

3. The method of claim 1, wherein the at least one individual health assessment comprises a general overview of health during preconception.

4. The method of claim 3, wherein the general overview of health includes at least one member selected from the group consisting of: a visit to an obstetrician, a visit to a nutritionist, an anthropometric assessment, a nutritional intake assessment, a sleep evaluation, a stress evaluation, and an exercise program.

5. The method of claim 1, wherein the at least one genomics analysis comprises MTHFR C677T/A1298C, 3 SNPs of COMT, and others with interpretations and assessments.

6. The method of claim 1, wherein the at least one initial laboratory test includes at least one member selected from the group consisting of: a comprehensive metabolic panel, a complete blood panel, a thyroid panel, an essential fatty acid panel, and at least one vitamin test.

7. The method of claim 1, wherein the at least one secondary laboratory test includes at least one member selected from the group consisting of: a complete blood panel, a comprehensive metabolic panel, a thyroid panel, at least one vitamin test, and analysis for at least one of the following: vitamin D, iron, zinc, carnitine, thyroid panel, 1 HR GTT, rubella, hepatitis B surface antigen, RPR, blood type, RH factor, chlamydia, gonorrhea, HIV, and a group B strep analysis.

8. The method of claim 1, wherein the at least one supplement is a preGenesis® prenatal supplement.

9. The method of claim 1, wherein the step of recording food intake and general pregnancy information during duration of the pregnancy and subsequent to the pregnancy, further includes recording on a data storage device.

10. The method of claim 1, wherein the data storage device includes at least one member selected from the group consisting of: a server, a database, a processor, a cloud network, and a call center.

11. The method of claim 1, wherein the method utilizes a software application to enable access to the data storage device.

12. The method of claim 1, wherein the method is administered by a caregiver.

13. The method of claim 12, wherein the caregiver includes at least one member selected from the group consisting of: an obstetrician, a doctor, a surgeon, a midwife, a nursing mother, a nutritionist/dietitian, and a personal trainer.

14. A method for health assessment and nutritional fortification during pregnancy, the method comprising:
performing at least one individual health assessment during preconception;
performing at least one genomics analysis pertinent to the pregnancy to at least partially understand a biological system;
performing at least one initial laboratory test during preconception to assess maternal health;
performing at least one secondary laboratory test during duration of the pregnancy and subsequent to the pregnancy to assess maternal health;
providing a nutritional plan during duration of the pregnancy and subsequent to the pregnancy to enhance maternal health;
providing a supplemental program during duration of the pregnancy and subsequent to the pregnancy, the supplemental program comprising at least one supplement; and
recording food intake and general pregnancy information during duration of the pregnancy and subsequent to the pregnancy.

15. The method of claim 14, further including a step of formulating an individual pregnancy plan during the duration of the pregnancy and subsequent to the pregnancy, the individual pregnancy plan based on at least one of the following: the at least one health assessment, the at least one genomics analysis, at least one initial laboratory test, at least one secondary laboratory test, the nutritional plan, and the supplemental program.

16. The method of claim 14, further including a step of providing at least one premade nutritional meal subsequent to the pregnancy.

17. The method of claim 14, wherein the at least one supplement includes at least one member selected from the group consisting of: at least one probiotic, at least one vitamin, at least one omega-3 fatty acid, at least one methyl folate, and a preGenesis® prenatal supplement.

18. The method of claim 14, wherein the at least one genomics analysis comprises MTHFR C677T/A1298C, 3 SNPs of COMT, and others with interpretations and assessments.

19. The method of claim 14, wherein the at least one initial laboratory test includes at least one member selected from the group consisting of: a comprehensive metabolic panel, a complete blood panel, a thyroid panel, an essential fatty acid panel, and at least one vitamin test.

20. The method of claim 14, wherein the at least one secondary laboratory test includes at least one member selected from the group consisting of: a complete blood panel, a comprehensive metabolic panel, a thyroid panel, at least one vitamin test, and analysis for at least one of the following: vitamin D, iron, zinc, carnitine, thyroid panel, 1 HR GTT, rubella, hepatitis B surface antigen, RPR, blood type, RH factor, chlamydia, gonorrhea, HIV, and a group B strep analysis.
